(19) United States
(12) Patent Application Publication
(10) Pub. No.: US 2016/0237853 A1
(43) Pub. Date: Aug. 18, 2016

(54) TURBINE EXHAUST CASE WITH COATED COOLING HOLES

(71) Applicant: UNITED TECHNOLOGIES CORPORATION, Hartford, CT (US)

(72) Inventor: Meggan Harris, Colchester, CT (US)

(21) Appl. No.: 15/029,444

(22) PCT Filed: Oct. 3, 2014
(86) PCT No.: PCT/US2014/059099

§ 371 Date: Apr. 14, 2016

Related U.S. Application Data
(60) Provisional application No. 61/892,886, filed on Oct. 18, 2013.

(51) Int. Cl. F01D 25/12; F01D 25/14; F01D 25/30; F01D 9/04

(52) U.S. Cl. CPC F01D 25/12; F01D 9/04; F01D 25/145; F01D 25/30; F05D 2300/175; F05D 2260/20; F05D 2230/90; F05D 2230/31; F05D 2230/80; F05D 2240/128; F05D 2260/202

(57) ABSTRACT

An effusion-cooled component includes a base portion defining at least one oversized cooling hole preform. A coating is disposed on the base portion and at least partially covers the oversized cooling hole preform to define a cooling hole. The component may be repaired by removing the coating from a component, visually inspecting the resultant base, and re-coating the base with a coating that oversprays to at least partially fill the oversized cooling preforms to define a plurality of cooling holes.

### BACKGROUND

Turbine exhaust case assemblies include inner and outer rings that are spaced from one another by a plurality of radially extending struts. These struts are fixedly attached at both their inner and outer ends to the inner and outer rings. The outer ring defines the radially outer surface of the engine gas flow path downstream of the last stage of turbine blades of a gas turbine engine.

Due to the high temperature of the exhaust flow path, thermal protection systems are used to prevent damage to the turbine exhaust case. Thermal barrier coatings can be applied to the exhaust case. Furthermore, cooling air may be used to effect effusion cooling and/or impingement cooling. Common exhaust cases are formed of a metal alloy, then coated with a coating such as a thermal barrier coating. Effusion cooling holes are then formed in the case, often by laser ablation or electrical discharge machining Cooling air, such as bypass air, may then be routed from radially outside the turbine exhaust case through the effusion cooling holes and into the exhaust flow path, preferably forming an effusion film of cool bypass air along the surface of the case that would otherwise be exposed to hot core flow.

Cooling air may be routed into the exhaust flow path for other purposes than for the protection of the turbine exhaust case. For example, diffusion cooling holes may also be present in the turbine exhaust case that promote mixing of cooling air with exhaust gases to modify engine acoustics, exhaust temperature, or promote combustion in an augmentor or afterburner. Effusion cooling holes are distinct from diffusion cooling holes in that effusion air is routed along the surface of the turbine exhaust case, rather than into the exhaust gas flow. By arranging several effusion cooling holes together, an effusion cooling film is generated that protects the TEC from damage. In order to maximize the efficacy of the effusion film, effusion cooling hole spacing and orientation are selected based on expected exhaust gas temperature and velocity at each location.

### SUMMARY

An effusion-cooled component includes a base portion defining at least one oversized cooling hole preform. A coating is disposed on the base portion and at least partially covers the oversized cooling hole preform to define a cooling hole. The component may be repaired by removing the coating from a component, visually inspecting the resultant base, and re-coating the base with a coating that oversprays to at least partially fill the oversized cooling preforms to define a plurality of cooling holes.

### BRIEF DESCRIPTION OF THE DRAWINGS

FIG. 1 is a perspective view of a turbine exhaust case.

FIGS. 2A-2D are cross-sectional views of two cooling holes undergoing construction, coating, wear, and un-coating, respectively.

### DETAILED DESCRIPTION

In order to provide an effusion cooling film in a turbine exhaust case, cooling holes are defined in the case to permit the passage of relatively cooler bypass air through the case. Portions of the turbine exhaust case are made by creating a base portion with oversized cooling hole preforms, then coating the base—including cladding the oversized cooling hole preforms—with a coating. The deposition of the coating in the oversized cooling hole preforms creates cooling holes of the desired size. A turbine exhaust case made in this manner may be repaired by removing the coating and re-applying a new coating without having to create new cooling holes in the case.

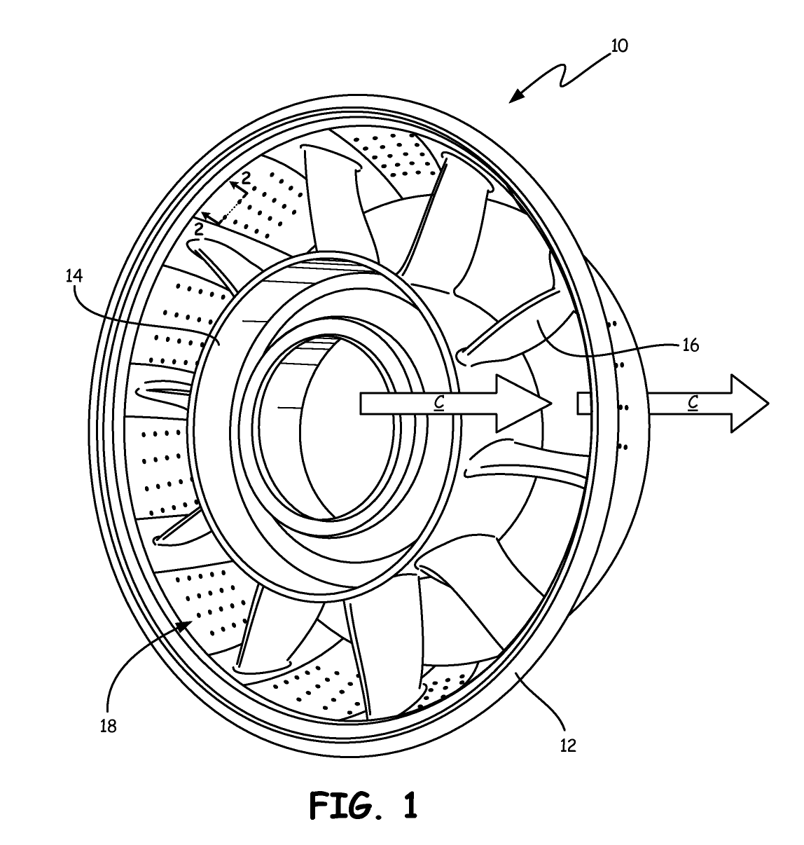

FIG. 1 is a perspective view of turbine exhaust case (TEC) 10. TEC 10 includes outer ring 12 and inner ring 14, which are connected to one another by a plurality of struts 16. TEC 10 defines the radially outer extent of core flow C. Outer ring 12 defines a plurality of cooling hole structures 18. As used in this application, the terms “cooling hole” and “effusion hole” are interchangeable. It will be understood by a person of ordinary skill in the art that the cooling holes described herein could be used in a combustor, turbine exhaust case, or any other part that benefits from effusion cooling.

TEC 10 is a component of a gas turbine engine. During normal operation, core flow C passes through a combustor (not shown), is routed through a turbine section (not shown), and then passes through TEC 10. The TEC can be fabricated using several methods. One such method is Laser Powder Deposition (LPD). In this method, either a portion of the TEC or the entire TEC can be built layer by layer which allows for various features to be included therein. Alternatively, TEC can be manufactured using casting or molding.

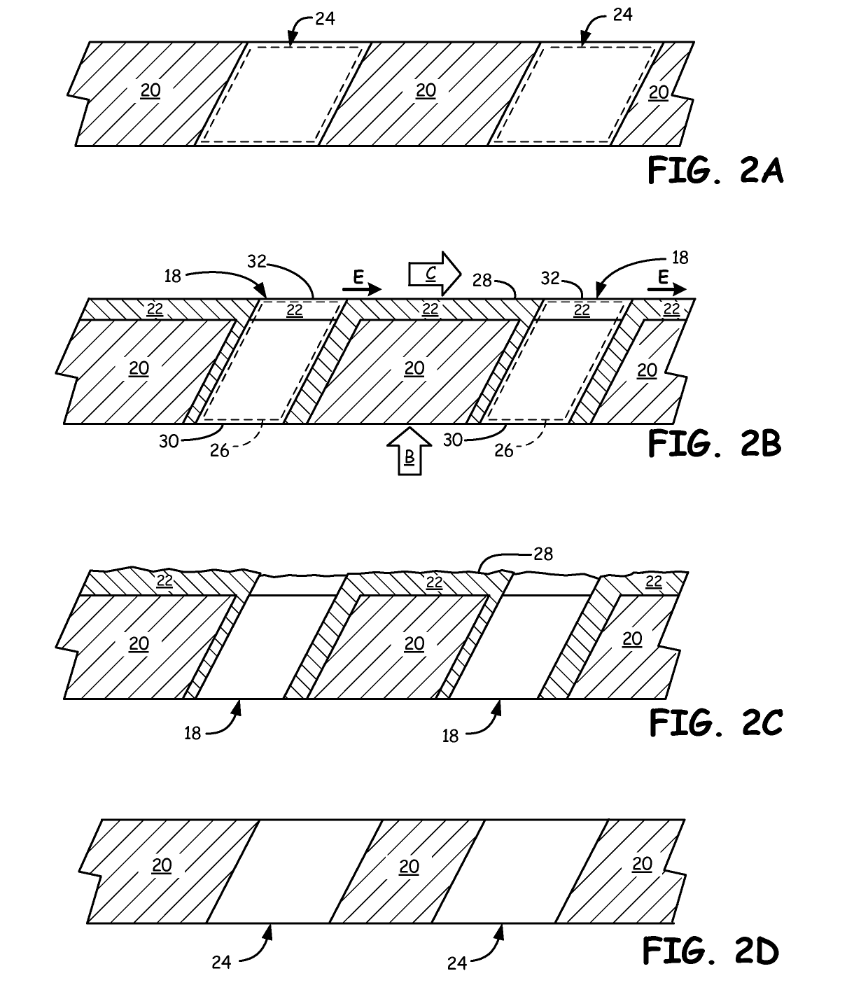

Core flow C passes through the region between outer ring 12 and inner ring 14. Core flow C may be sufficiently hot to cause damage to outer ring 12, inner ring 14, or struts 16. In the embodiment shown in FIG. 1, outer ring 12 is protected from such damage by at least two mechanisms: a thermal barrier coating, and an effusion cooling film. Effusion cooling is accomplished by routing cooling air, for example bypass air, through effusion cooling hole structures 18 to form an effusion film (e.g. effusion film E of FIG. 2). Effusion cooling hole structures 18 are only shown in outer ring 12 of TEC 10. However, in alternative embodiments, effusion cooling hole structures 18 may also be present in struts 16 and/or inner ring 14.

FIGS. 2A-2D are cross-sectional views of two cooling hole structures 18 within outer ring 12 of FIG. 1, taken along line 2-2. In particular, FIG. 2A illustrates base 20 including two oversized cooling hole preforms 24. FIG. 2B illustrates deposition of coating 22, including within oversized cooling hole preforms 24 to provide cooling holes 26 having a desired size. FIG. 2C illustrates the base 20 and coating 22 of FIGS. 2A-2B after use, such that coating 22 is in need of refurbishment or repair. FIG. 2D illustrates base 20 after coating 22 has been removed as part of a refurbishment or repair process.

FIG. 2A is a cross-sectional view of base 20 including two oversized cooling hole preforms 24. In this embodiment, oversized cooling hole preforms 24 are designed as straight, slanted holes in base 20. Oversized cooling hole preforms 24 are larger than a desired final cooling hole size.

In some embodiments, base 20 may include a bond coat (not shown). Such bond coats may be used to promote adhesion between base 20 and an adjacent material, such as coating 22 (FIGS. 2B-2C).

Cooling hole structures 18 are defined by base 20 and coating 22. Base 20 is manufactured to define oversized cooling hole preforms 24. Base 20 may be made by additive manufacturing, such as direct metal laser sintering, laser powder deposition, or other additive methods. Oversized cooling hole preforms 24 can be included in base 20 as it is built. Alternatively, base 20 may be made by casting or molding, then oversized cooling hole preforms 24 may be created by electro-discharge machining (EDM), laser ablation, or other known subtractive manufacturing techniques.

Additive manufacturing may be used to define oversized cooling hole preforms 24 that have complex geometries not easily generated using laser ablation of EDM. Such geometries include tapered cooling holes, lobed cooling holes, or groups of cooling holes with non-uniform angles. In addition, additive manufacturing can easily form oversized cooling hole preforms 24 that are large enough that they would be expensive and/or time consuming to create using traditional subtractive manufacturing mechanisms. Various additive manufacturing mechanisms may be used, including direct metal laser sintering, laser powder deposition, selective laser sintering, and electron beam melting, among others. Additive manufacturing can be used to build up layers of a meltable, sinterable, or polymerizable material into a complex, multilayered structure.

FIG. 2B is a cross-sectional view of base 20, as well as coating 22, deposited to form cooling hole structures 18. In particular, FIG. 2B illustrates two cooling hole structures 18, configured to direct bypass air B to an effusion film E to protect surface 28 from damage from core flow C.

Coating 22 is applied after base 20—including oversized cooling hole preforms 24—is completely formed, as described with respect to FIG. 2A. Coating 22 oversprays to at least partially fill oversized cooling hole preforms 24. Effusion holes 26 are defined and shaped as a result of the underlying structure of oversized cooling hole preforms 24. Due to coating 22 overspraying onto the edges of base 20 that define oversized cooling hole preforms 24, cooling holes 26 may be completely, or at least partially, clad with coating 22. The thickness of such cladding is a function of the angle at which the coating is applied, as well as the thickness of coating 22.

Components with clad cooling holes prevent exposure of base 20 to external elements, ranging from thermal energy to radar waves. For example, coating 22 (FIGS. 2B-2C) may be of a material that does not have a high reflectance, as compared to the metal alloys typically used to form base 20. Devices that rely on reflected or radiated waves may not identify aircraft incorporating clad cooling holes as easily as those without.

Effusion holes 26 include inlet 30 and outlet 32, which are apertures that allow ingress and egress of bypass air B, respectively, to cooling holes 26. Inlet 30 and outlet 32 are fluidically connected to permit fluid flow from bypass air B to effusion film E. In alternative embodiments, a bond coating, such as a bimetallic material, may be applied to base 20 prior to coating 22.

Surface 28 of coating 22 is exposed to core flow C. Surface 28 is protected from damage that could be caused by core flow C by effusion film E. Inlet 30 and outlet 32 are configured to optimize effusion film E. By changing the size, shape, or tapering of oversized cooling hole preform 24, various structures may be generated in surface 28, inlet 30, and/or outlet 32 that accelerate fluid flow in a desired direction to promote laminar flow in effusion film E.

Effusion film E may be directed in any desired direction to protect a portion of outer ring 12. In some embodiments, such as the one shown in FIG. 2B, effusion film E may be directed parallel to core flow C. In other embodiments, effusion film E may be perpendicular, opposite, or any other direction with respect to core flow C. Furthermore, in some embodiments, core flow C may not flow parallel to the plan defined by surface 28.

FIG. 2C shows the base 20 and coating 22 of FIGS. 2A and 2B. As shown in FIG. 2C, coating 22 has been damaged by core flow C of FIG. 2B, such that surface 28 is uneven. Thus, coating 22 must be refurbished or replaced.

Oversized cooling hole preforms 24 allow for a cycle of repair or refurbishment. Prior art components are coated and then cooling holes are manufactured subtractively. Thus, if the coating were to be removed from a prior art component, and the component were then re-coated, the base would be filled by the coating to an unacceptable extent. In order to create acceptable cooling holes, such prior art components would have to be coated and then undergo a second round of subtractive manufacturing. This second round of subtractive manufacturing results in a second set of holes punched through the base. Unlike these prior art components, base 20 of FIGS. 2A-2D may be refurbished and recoated many times without the need for additional subtractive manufacturing thereon.

FIG. 2D shows the base 20 of FIGS. 2A-2C, with coating 22 removed. Removal of coating 22 may be accomplished, for example, by water spraying. Base 20 can be visually inspected to ensure that coating 22 has been removed. Once coating 22 has been removed, base 20 may be re-clad with coating 22, as previously described with respect to FIG. 2B, to refurbish cooling hole structures 18. In this way, coating 22 and cooling holes 26 may be refurbished or repaired without having to manufacture new cooling holes.

### DISCUSSION OF POSSIBLE EMBODIMENTS

The following are non-exclusive descriptions of possible embodiments of the present invention.

According to one embodiment, an effusion-cooled component includes a base portion defining an oversized cooling hole preform. The component further includes a coating disposed on the base portion and at least partially covering the oversized cooling hole preform to define a cooling hole.
The effusion-cooled component of the preceding paragraph can optionally include, additionally and/or alternatively, any one or more of the following features, configurations and/or additional components:
The base may include a high temperature superalloy. The coating may be a thermal barrier coating. The effusion-cooled component may also include a cooling air source on a radially outer side of the outer ring adjacent to the cooling hole at an inlet. The effusion-cooled component may also be arranged adjacent to a core flow on a radially inner side of the outer ring adjacent to the cooling hole at an outlet. The cooling hole may be one of a plurality of cooling holes defined by the effusion-cooled component, wherein the plurality of cooling holes are arranged to provide an effusion film.
In another embodiment, a method of manufacturing an effusion-cooled component includes forming a base defining a plurality of oversized cooling preforms, then coating the base with a coating that oversprays to at least partially fill the oversized cooling preforms to define a plurality of cooling holes.
The method of the preceding paragraph can optionally include, additionally and/or alternatively, any one or more of the following features, steps, configurations and/or additional components:
The method may include applying a bond coating to the base after forming the base and prior to coating the base. Forming the base portion may include additively manufacturing the base portion. Additively manufacturing the base portion may include using laser powder deposition to create a multilayered structure. The method may also include routing a cooling fluid to an inlet of the cooling hole, routing a core flow to an outlet of the cooling hole, and routing the cooling fluid through the cooling hole from the inlet to the outlet to provide an effusion film adjacent to the outlet of the cooling hole.
In another embodiment, a method for repairing a component including a cooling hole includes removing a coating from a component. The component includes a base defining an oversized cooling hole preform, and a coating at least partially covering the base, including at least partially filling the oversized cooling hole preform to define a cooling hole. The method also includes visually inspecting the resultant base, and coating the base with a coating that oversprays to at least partially fill the oversized cooling preforms to define a plurality of cooling holes.
The method of the preceding paragraph can optionally include, additionally and/or alternatively, any one or more of the following features, steps, configurations and/or additional components:
Removing the coating from the component may include using a water jet to remove the coating. Visually inspecting the resultant base may include inspecting the base to ascertain what portion of the coating was removed from the base. Removing the coating from the component may include removing all of the coating from the base.

Although the present invention has been described with reference to preferred embodiments, workers skilled in the art will recognize that changes may be made in form and detail without departing from the spirit and scope of the invention.

1. An effusion-cooled component comprising:
a base portion defining an oversized cooling hole preform; and
a coating disposed on the base portion and at least partially covering the oversized cooling hole preform to define a cooling hole.

2. The effusion-cooled component of claim 1, wherein the base includes a high temperature superalloy.

3. The effusion-cooled component of claim 1, wherein the coating is a thermal barrier coating.

4. The effusion-cooled component of claim 1, and further comprising a cooling air source on a radially outer side of the outer ring adjacent to the cooling hole at an inlet.

5. The effusion-cooled component of claim 4, wherein the effusion-cooled component is arranged adjacent to a core flow on a radially inner side of the outer ring adjacent to the cooling hole at an outlet.

6. The effusion-cooled component of claim 5, wherein the cooling hole is one of a plurality of cooling holes defined by the effusion-cooled component, wherein the plurality of cooling holes are arranged to provide an effusion film.

7. A method of manufacturing an effusion-cooled component, the method comprising:
forming a base defining a plurality of oversized cooling preforms; and
coating the base with a coating that oversprays to at least partially fill the oversized cooling preforms to define a plurality of cooling holes.

8. The method of claim 7, and further comprising applying a bond coating to the base after forming the base and prior to coating the base.

9. The method of claim 7, wherein forming the base portion comprises additively manufacturing the base portion.

10. The method of claim 9, wherein additively manufacturing the base portion comprises using laser powder deposition to create a multilayered structure.

11. The method of claim 7, and further comprising:
routing a cooling fluid to an inlet of the cooling hole;
routing a core flow to an outlet of the cooling hole; and
routing the cooling fluid through the cooling hole from the inlet to the outlet to provide an effusion film adjacent to the outlet of the cooling hole.

12. A method for repairing a component including a cooling hole, the method comprising:
removing a coating from a component, wherein the component includes:
a base defining an oversized cooling hole preform; and
a coating at least partially covering the base, including at least partially filling the oversized cooling hole preform to define a cooling hole;
visually inspecting the resultant base; and
coating the base with a coating that oversprays to at least partially fill the oversized cooling preforms to define a plurality of cooling holes.

13. The method of claim 12, wherein removing the coating from the component comprises using a water jet to remove the coating.

14. The method of claim 12, wherein visually inspecting the resultant base comprises inspecting the base to ascertain what portion of the coating was removed from the base.

15. The method of claim 12, wherein removing the coating from the component comprises removing all of the coating from the base.
